(19) United States
(12) Patent Application Publication
(10) Pub. No.: US 2014/0052367 A1
(43) Pub. Date: Feb. 20, 2014

(54) OPERATING A DRIVER ASSISTANCE SYSTEM OF A MOTOR VEHICLE AND DRIVER ASSISTANCE SYSTEM

(71) Applicant: GM GLOBAL TECHNOLOGY OPERATIONS LLC, Detroit, MI (US)

(72) Inventor: Uwe HAHNE, Buettelborn (DE)

(73) Assignee: GM GLOBAL TECHNOLOGY OPERATIONS LLC, Detroit, MI (US)

(21) Appl. No.: 13/968,537

(22) Filed: Aug. 16, 2013

(30) Foreign Application Priority Data
Aug. 16, 2012 (DE) 10 2012 016 366.5

(51) Int. Cl. G08G 1/00

(52) U.S. Cl. CPC G08G 1/00
USPC 701/119

(57) ABSTRACT

A method is provided for operating a driver assistance system of a motor vehicle that includes, but is not limited to determining of a current speed and determining a current speed of further road users located in a longitudinal direction of the motor vehicle in front of the motor vehicle. In the event the determined current speed of the motor vehicle does not exceed a first predetermined threshold value does not exceed a second predetermined threshold value, a repeated determining of the current speed of the road user located directly in front of the motor vehicle takes place. In the event that the determined current speed of the road user does not exceed the second predetermined threshold value and the determined current speeds the determined further road users do not exceed the second predetermined threshold value, a repeated determining of the current speed.

### CROSS-REFERENCE TO RELATED APPLICATION

This application claims priority to Patent Application No. 10 2012 016 366.5, filed Aug. 16, 2012, which is incorporated herein by reference in its entirety.

### TECHNICAL FIELD

The technical field relates to a method for operating a driver assistance system of a motor vehicle, a driver assistance system for a motor vehicle, a computer program product and a computer-readable medium.

### BACKGROUND

From DE 10 2007 029 482 A1 a driver assistance system for motor vehicles with a sensor device for detecting a situation, in which a starting of the vehicle is possible, and a control device for outputting a starting cue to the driver is known. The control device is designed, upon detecting a starting situation, to output a haptic starting cue or initially a visual starting cue and then with a time delay an acoustic and/or haptic starting cue.

In view of the foregoing, it is at least one object of the application to provide state a method for operating a driver assistance system of a motor vehicle, a driver assistance system for a motor vehicle, a computer program product and a computer-readable medium, which make possible an improvement of a traffic flow. In addition, objects, desirable features and characteristics will become apparent from the subsequent summary and detailed description, and the appended claims, taken in conjunction with the accompanying drawings and this background.

### SUMMARY

According to an embodiment, a method is provided for operating a driver assistance system of a motor vehicle. The method includes, but is not limited to determining of a current speed of the motor vehicle takes place, a determining of a current speed of further road users located in a longitudinal direction of the motor vehicle in front of the motor vehicle takes place. In the event that the determined current speed of the motor vehicle does not exceed a first predetermined threshold value and in the event that the determined current speed of a road user located directly in front of the motor vehicle does not exceed a second predetermined threshold value, a repeated determining of the current speed of the road user located directly in front of the motor vehicle takes place. In the event that the repeatedly determined current speed of the road user located directly in front of the motor vehicle does not exceed the second predetermined threshold value and in the event that the determined current speeds of all of the determined further road user do not exceed the second predetermined threshold value, a repeated determining of the current speed of the determined further road users takes place. In the event that the repeatedly determined current speed of at least one of the determined further road users exceeds the second predetermined threshold value, an outputting of a starting cue by means of an output device of the driver assistance system takes place.

The method makes possible an improvement of a traffic flow. This takes place by determining if the repeatedly determined current speed of at least one of the determined further road users exceeds the second predetermined threshold value, in the event that the repeatedly determined current speed of the road user located directly in front of the motor vehicle does not exceed the second predetermined threshold value, and through the outputting of the starting cue, in the event that the repeatedly determined current speed of at least one of the determined further road users exceeds the second predetermined threshold value. Outputting the starting cue thus takes place in the mentioned embodiment when at least one of the determined further road users exceeds the second speed threshold value. For example when road users generally located in front of the motor vehicle start moving again, although the road user located directly in front of the motor vehicle for example is still stationary. This informs the occupants of the motor vehicle, in particular the driver of the motor vehicle, in a timely manner regarding a possible restarting or a possible acceleration of the motor vehicle. Thus, the driver can start again timely even taking into account delay times in his reaction. This does not impair traffic flow or only to the least possible degree. In addition, the driver of the motor vehicle can relax pending the output of the starting cue, which advantageously contributes to a well-being of the driver.

The second predetermined threshold value can correspond to the first predetermined threshold value. For example, the first predetermined threshold value and the second predetermined threshold value can each amount to approximately 0 km/h or approximately 10 km/h each. In the first mentioned case the first predetermined threshold value characterize a stationary state of the motor vehicle and the second predetermined threshold value a stationary state of the road user located directly in front of the motor vehicle or of the determined further road users. Furthermore, the second predetermined threshold value can be distinct from the first predetermined threshold value. For example, the first predetermined threshold value can be approximately 0 km/h and the second predetermined threshold value approximately 10 km/h.

Determining of the current speed of the further road users located in a longitudinal direction of the motor vehicle in front of the motor vehicle preferably includes a determining of a current speed of further motor vehicles located in the longitudinal direction of the motor vehicle in front of the motor vehicle. Typically, the further motor vehicles in this case are located on a lane travelled by the motor vehicle equipped with the driver assistance system. These road users are of particular relevance to a possible starting of the motor vehicle.

In the event that the repeatedly determined current speed of at least one of the determined further road users exceeds the second predetermined threshold value, an acceleration of the at least one further road user and/or a distance of the at least one further road user relative to the motor vehicle is determined in a further embodiment. In this embodiment, a point of time at which the outputting of the starting cue takes place is determined based on the determined acceleration and/or the determined distance. From the mentioned quantities, a point of time at which the motor vehicle can start again or accelerate again can be deduced to as accurate as possible a degree. The point of time at which the outputting of the starting cue takes place in this case is a predetermined period of time before the possible restarting of the motor vehicle, for example two to three seconds before the possible restarting. This informs the driver of the motor vehicle of the possibility of restarting or reaccelerating at a particularly suitable point of time.

In addition, an outputting of a starting cue with the output device of the driver assistance system can take place in the event that the repeatedly determined current speed of the road user located directly in front of the motor vehicle does not exceed the second predetermined threshold value and in the event that the determined current speed of at least one of the determined further road users exceeds the second predetermined threshold value.

Determining of the current speed of the further road user, the repeated determining of the current speed of the road user located directly in front of the motor vehicle and/or the repeated determining of the current speed of the determined further road users can take place based on data determined by at least one sensor of the motor vehicle. The at least one sensor in this case is preferably selected from the group consisting of an electromagnetic sensor, in particular a radar sensor or a lidar sensor, an acoustic sensor, in particular an ultrasound sensor, and an optical camera. The mentioned sensors, which are also called surround sensors, are provided to an increased degree in motor vehicles, as a result of which the number of components needed for the method can be advantageously reduced.

Furthermore, determining of the current speed of the further road users, the repeated determining of the current speed of the road users located directly in front of the motor vehicle and/or the repeated determining of the current speed of the determined further road users can take place based on data received with a Vehicle-to-Vehicle communication device of the motor vehicle.

In the event that the determined current speed of the motor vehicle does not exceed the first predetermined threshold value, it is additionally determined in a further embodiment if a set of traffic lights is located in the range of a surroundings located in front of the vehicle. In the event that it is determined that a set of traffic lights is present in the range, the outputting of the starting cue in this embodiment additionally takes place as a function of a light signal output by the set of traffic lights. For example, the outputting of the starting cue takes place even when all of the determined further road users are stationary, i.e., have not yet started to move or the repeatedly determined current speeds of all of the determined further road users do not exceed the second predetermined threshold value and a light signal of the set of traffic lights characterizing a stopping command.

The light signal output by the set of traffic lights in this case can be determined based on data received by means of a Vehicle-to-Vehicle infrastructure communication device. Furthermore, the light signal output by the set of traffic lights can also be determined based on data determined by at least one optical camera of the motor vehicle. Furthermore, in the case that the determined current speed of the motor vehicle does not exceed the first predetermined threshold value it can be determined if a level crossing barrier is located in the range of a surroundings located in front of the motor vehicle. In the event that it is determined that a level crossing barrier is located in the range, the outputting of the starting cue in this embodiment additionally takes place as a function of an opening state of the level crossing barrier. For example, the outputting of the starting cue takes place even when all of the determined further road users are stationary or the repeatedly determined current speeds of all of the determined further road users do not exceed the second predetermined threshold value and an opening of the level crossing barrier is determined. Furthermore, the outputting of the starting cue can also take place when no further road users are located in front of the motor vehicle on the level crossing barrier and an opening of the level crossing barrier is determined.

The opening state of the level crossing barrier in this case can again be determined based on data received with a Vehicle-to-Vehicle infrastructure communication device. Furthermore, the opening state of the level crossing barrier can be determined based on data determined by at least one optical camera of the motor vehicle.

In a further embodiment of the method, a type of a road currently travelled by the motor vehicle is additionally determined. In this embodiment, an adapting of the first predetermined threshold value and/or of the second predetermined threshold value as a function of the determined type of the road currently travelled by the motor vehicle takes place. For example, the first predetermined threshold value and/or the second predetermined threshold value can be increased in the event that the road currently travelled by the motor vehicle is a highway or a motorway. Furthermore, the first predetermined threshold value and/or the second predetermined threshold value can be reduced in the event that the road currently travelled by the motor vehicle is a road located within a built-up area. The type of the road currently travelled by the motor vehicle in this case can for example be determined by means of map data stored in a storage device of the motor vehicle.

The driver assistance system can be additionally designed for the automatic actuating of a driving device of the motor vehicle. In this configuration, the outputting of the starting cue includes an outputting of information regarding an imminent automatic actuation of the driving device. Therefore, the occupants, particularly the driver, of the motor vehicle are informed the imminent automatic restarting of the motor vehicle.

A driver assistance system is provided for a motor vehicle. The driver assistance system comprises a first determining device, which is designed for determining a current speed of the motor vehicle. In addition, the driver assistance system comprises a second determining device, which is designed for determining a current speed of further road users located in a longitudinal direction of the motor vehicle in front of the motor vehicle. Furthermore, the driver assistance system comprises a third determining device. In the event that the determined current speed of the motor vehicle does not exceed a first predetermined threshold value and it is determined that the determined current speed of a road user located directly in front of the motor vehicle does not exceed a second predetermined threshold value, the third determining device is designed for the repeated determining of the current speed of the road user located directly in front of the motor vehicle. If the repeatedly determined current speed of the road user located directly in front of the motor vehicle does not exceed the second predetermined threshold value and in the event that the determined current speed of all of the determined further road users do not exceed the second predetermined threshold value, the third determining device is designed furthermore for repeatedly determining the current speed of the determined further road users. In addition, the driver assistance system comprises an output device, which is designed for outputting a starting cue, in the event that the repeatedly determined current speed of at least one of the determined further road users exceeds the second predetermined threshold value. The driver assistance system according to the application has the advantages already mentioned in connection with the method according to the application, which at this point are not mentioned again to avoid repetitions.

The second determining device in this case is preferably designed for determining a current speed of further motor vehicles located in the longitudinal direction of the motor vehicle in front of the motor vehicle, in particular of further motor vehicle located on a lane travelled by the motor vehicle. Furthermore, the third determining device can be additionally designed for determining a point of time, at which the outputting of the starting cue takes place, based on a determined acceleration of the at least one further road user and/or a determined distance of the at least one further road user relative to the motor vehicle, in the event that the repeatedly determined current speed of at least one of the determined further road users exceeds the second predetermined threshold value. The output device is preferably designed as a visual and/or acoustic and/or haptic output device. Therefore, the driver of the motor vehicle in particular can be reliably informed of the possibility of the starting or accelerating of the motor vehicle.

Furthermore, a computer program product is provided which, when it is executed on a computer unit of a driver assistance system of a motor vehicle, instructs the computer unit to carry out the following steps. The computer unit is instructed for determining a current speed of the motor vehicle. In addition, the computer unit is instructed for determining a current speed of further road users located in a longitudinal direction of the motor vehicle in front of the motor vehicle. In the event that the determined current speed of the motor vehicle does not exceed a predetermined threshold value and in the event that the determined current speed of a road user located directly in front of the motor vehicle does not exceed a second predetermined threshold value, the computer unit is instructed for repeatedly determining the current speed of the road user located directly in front of the motor vehicle. In the event that the repeatedly determined current speed of the road user located directly in front of the motor vehicle does not exceed the second predetermined threshold value and in the event that the determined current speeds of all of the determined further road users do not exceed the second predetermined threshold value, the computer unit is instructed furthermore for repeatedly determining the current speed of the determined further road users. In the event that the repeatedly determined current speed of at least one of the determined further road users exceeds the second predetermined threshold value, the computer unit is additionally instructed for outputting a starting cue by means of an output device of the driver assistance system.

The application furthermore relates to a computer-readable medium, on which a computer program product according to the mentioned embodiment is stored. The computer program product and the computer-readable medium according to the application have the advantages already mentioned in connection with the method according to the application, which are not mentioned again at this point in order to avoid repetitions. In addition to this, the application relates to a motor vehicle comprising a driver assistance system according to one of the abovementioned embodiments. The motor vehicle is for example a passenger car or a commercial vehicle.

### BRIEF DESCRIPTION OF THE DRAWINGS

The present invention will hereinafter be described in conjunction with the following drawing figures, wherein like numerals denote like elements, and:

FIG. 1 shows a flow diagram of a method for operating a driver assistance system of a motor vehicle according to a first embodiment;

FIG. 2 shows a flow diagram of a method for operating a driver assistance system of a motor vehicle according to a second embodiment;

FIG. 3A and FIG. 3B show an example of a traffic situation, in which the methods according to the application can be employed; and

FIG. 4 shows a driver assistance system for a motor vehicle according to an embodiment.

### DETAILED DESCRIPTION

The following detailed description is merely exemplary in nature and is not intended to limit application and uses. Furthermore, there is no intention to be bound by any theory presented in the preceding background or summary or the following detailed description.

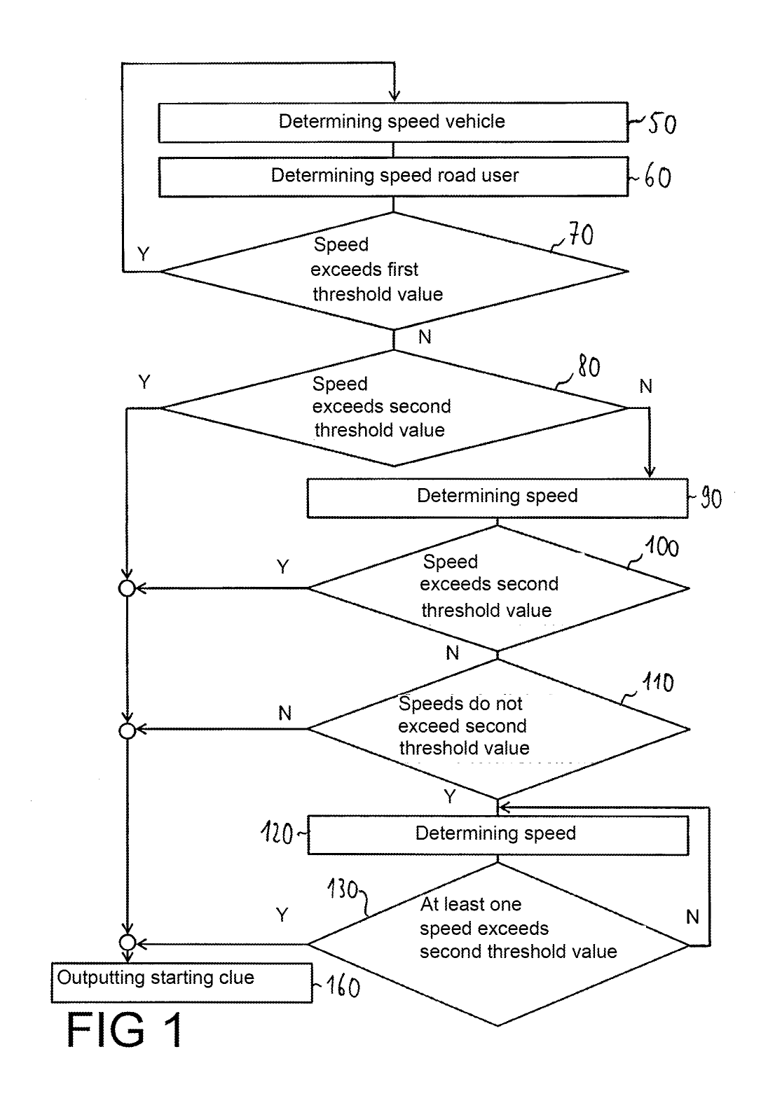

FIG. 1 shows a flow diagram of a method for operating a driver assistance system of a motor vehicle according to a first embodiment. The motor vehicle is for example a passenger car. In a step 50, a determining of a current speed of the motor vehicle, for example based on a determined current wheel rotational speed of the motor vehicle, takes place. In a step 60, a determining of a current speed of further road users located in a longitudinal direction of the motor vehicle in front of the motor vehicle takes place.

The motor vehicle and the further road users in this case are typically located on a common lane. Determining of the current speed of the further road users preferably includes a determining of a current speed of further motor vehicles located in the longitudinal direction of the motor vehicle in front of the motor vehicle. Here, determining of the current speed for example takes place based on data determined by at least one sensor of the motor vehicle, in particular based on data determined by an electromagnetic sensor, for example a radar sensor or a lidar sensor, and/or an acoustic sensor, for example an ultrasound sensor. In addition, determining of the current speed of the further road user can take place based on data received from a Vehicle-to-Vehicle communication device.

In a step 70 it is determined if the current speed of the motor vehicle exceeds a first predetermined threshold value. The first predetermined threshold value can in particular amount to approximately 0 km/h, i.e., it can be determined if the vehicle is stationary. In the event that the determined current speed exceeds the first predetermined threshold value, the steps 50, 60 and 70 are repeatedly carried out.

In the event that by contrast the determined current speed of the motor vehicle does not exceed the first predetermined threshold value, it is determined in a step 80 based on data determined in the step 60, if the determined current speed of a road user located directly in front of the motor vehicle does not exceed a second predetermined threshold value. The second predetermined threshold value can for example amount to 10 approximately km/h. Furthermore, the second predetermined threshold value can for example amount to approximately 0 km/h. In the last mentioned case, it is determined in the step 80 if the road user located directly in front of the motor vehicle is stationary.

In the event that the determined current speed of the road user located directly in front of the motor vehicle exceeds the second predetermined threshold value, for example in the event that the second predetermined threshold value amounts to approximately 0 km/h and the road user located directly in front of the motor vehicle is not stationary, an outputting of a starting cue in particular to the driver of the motor vehicle by means of an output device of the driver assistance system takes place in a step 160. For example, a visual and/or acoustic and/or haptic starting cue is output.

If, by contrast it is determined in the step 80 that the determined current speed of the road user located directly in front of the motor vehicle does not exceed the second predetermined threshold value, a repeated, i.e., renewed determining of the current speed of the road user located directly in front of the motor vehicle takes place in a step 90. Furthermore, it is determined in a step 100 based on the data determined in the step 90 if the repeatedly determined current speed of the road user located directly in front of the motor vehicle exceeds the second predetermined threshold value. It is determined, for example, if the road user located directly in front of the motor vehicle starts moving again, i.e., if the road user starts again, in the event that the second predetermined threshold value amounts to approximately 0 km/h.

If it is determined, in the process, that the repeatedly determined current speed of the road user located directly in front of the motor vehicle exceeds the second predetermined threshold value, for example in the event that the road user located directly in front of the motor vehicle starts moving again, an outputting of a starting cue with the output device, as in turn is shown by the step 160, takes place. If, by contrast, it is determined in the step 100 that the repeatedly determined current speed of the road user located directly in front of the motor vehicle does not exceed the second predetermined threshold value, for example in the event that the road user located directly in front of the motor vehicle has not started to move again, it is determined in a step 110 if the determined current speeds of all of the determined further road users do not exceed the second predetermined threshold value. To this end, the determined current speeds of the determined further road users are each compared with the second predetermined threshold value. It is determined, for example, if all of the determined further road users are stationary, in the event that the second predetermined threshold value amounts to approximately 0 km/h.

If it is determined, in the process, that the determined current speed of at least one of the determined further road users exceeds the second predetermined threshold value, a starting cue is output by means of the output device, as is shown by the step 160. If, by contrast, it is determined that the determined current speeds of all of the determined further road users do not exceed the second predetermined threshold value, for example in the event that all of the determined further road users are stationary, the current speed of the further road users is determined anew in a step 120.

In a step 130 it is determined based on the data determined in the step 120 if the repeatedly determined current speed of at least one of the determined further road users exceeds the second predetermined threshold value. To this end, the repeatedly determined current speeds of the determined further road users are each compared with the second predetermined threshold value. It is determined, for example if at least one of the determined further road users starts moving again in the event that the second predetermined threshold value amounts to approximately 0 km/h.

In the event that the repeatedly determined current speeds of all of the determined further road users do not exceed the second predetermined threshold value, for example in the event that none of the further road users starts moving again, the steps 120 and 130 are carried out repeatedly. In the event that it is determined, by contrast, that the repeatedly determined current speed of at least one of the determined further road users exceeds the second predetermined threshold value, for example in the event that at least one of the determined road users starts moving again, an outputting of a starting cue with the output device takes place in the step 160.

In a further configuration of the method it can be additionally determined in the event that the determined current speed of the motor vehicle does not exceed the first predetermined threshold value if a set of traffic lights is located in the range of a surroundings located in front of the motor vehicle. If a set of traffic lights is located in the range, the outputting of the starting cue in this configuration of the method can additionally take place as a function of a light signal output by the set of traffic lights. In particular, the outputting of the starting cue can take place in the event that for example it is determined by means of an optical camera of the motor vehicle with data received from a Vehicle-to-Vehicle infrastructure communication device that a light signal characterizing a stopping command of the set of traffic lights goes out.

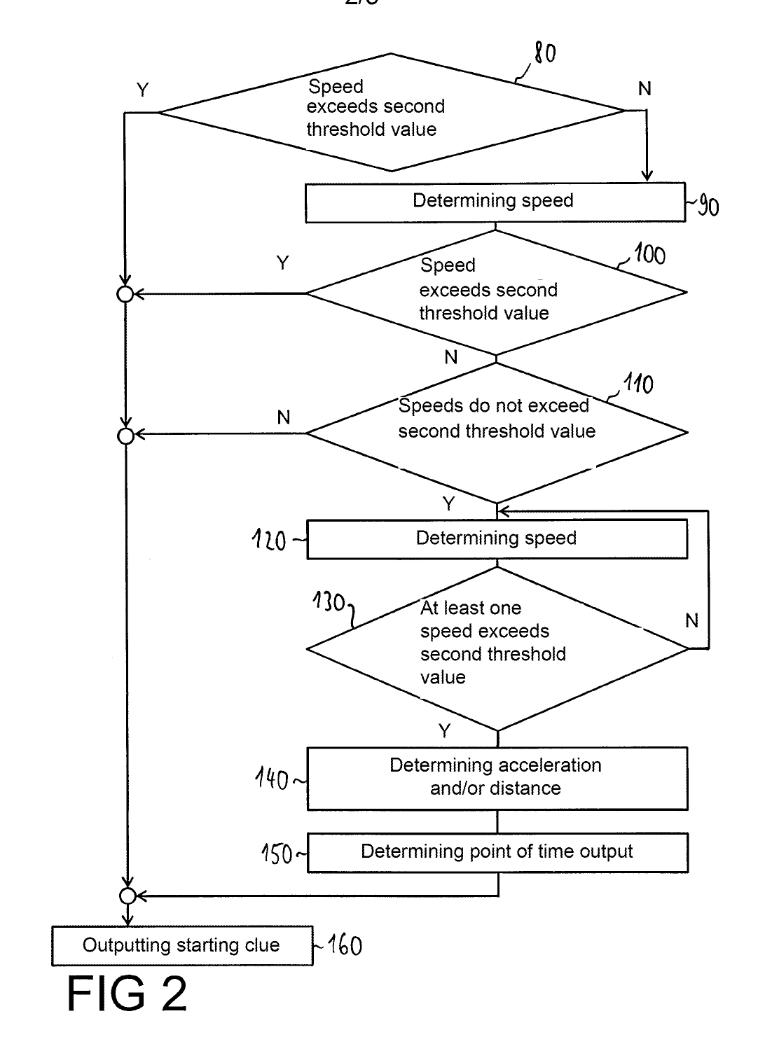

FIG. 2 shows a flow diagram of a method for operating a driver assistance system of a motor vehicle according to a second embodiment of the application. The motor vehicle is again a passenger car for example. In the shown second embodiment, a determining of a current speed of the motor vehicle and a determining of a current speed of further road users located in a longitudinal direction in front of the motor vehicle likewise takes place and a determining if the current speed of the motor vehicle exceeds a predetermined threshold value, corresponding to the steps 50, 60 and 70 of the first embodiment shown in FIG. 1. The mentioned steps are not shown in more detail in FIG. 2 for the sake of clarity.

In addition to this, in step 80, a determining if the determined current speed of a road user located directly in front of the motor vehicle does not exceed a second predetermined threshold value, corresponding to the step 80 of the first embodiment shown in FIG. 1, takes place. In particular, it can be determined again if the road user located directly in front of the motor vehicle is stationary.

In the event that the determined current speed of the road user located directly in front of the motor vehicle exceeds the second predetermined threshold value, for example in the event that the second predetermined threshold value amounts to approximately 0 km/h and the road user located directly in front of the motor vehicle is not stationary, an outputting of a starting cue with an output device of the driver assistance system takes place in a step 160. This likewise takes place according to the step 160 of the first embodiment shown in FIG. 1.

In the event that, by contrast, it is determined in the step 80 that the determined current speed of the road user located directly in front of the motor vehicle does not exceed the second predetermined threshold value, for example in the event that the road user located directly in front of the motor vehicle is stationary, a repeated determining of the current speed of the road user located directly in front of the motor vehicle takes place in a step 90. Furthermore it is determined in a step 100 if the repeatedly determined current speed of the road user located directly in front of the motor vehicle exceeds the second predetermined threshold value. It is determined for example if the road user located directly in front of the motor vehicle is starting to move again.

In the event that, in the process, it is determined that the repeatedly determined current speed of the road user located directly in front of the motor vehicle exceeds the second predetermined threshold value, for example in the event that the road user located directly in front of the motor vehicle is starting to move again, an outputting of a starting cue as shown by step 160 takes place.

In the event that, by contrast, the repeatedly determined current speed of the road user located directly in front of the motor vehicle does not exceed the second predetermined threshold value, for example in the event that the road user located in front of the motor vehicle does not start moving again, it is determined in a step 110 if the determined current speeds of all of the determined further road users do not exceed the second predetermined threshold value. It is determined, for example, if all of the determined further road users are stationary.

In the event that the determined current speed of at least one of the determined further road users exceeds the second predetermined threshold value, an outputting of a starting cue again takes place in the step 160. In the event that it is determined, by contrast, that the determined current speeds of all of the determined further road users do not exceed the second predetermined threshold value, for example in the event that all of the determined further road users are stationary, a repeated determining of the current speed of the further road users takes place in a step 120. It is determined, furthermore, in a step 130 if the repeatedly determined current speed of at least one of the determined further road users exceeds the second predetermined threshold value. It is determined, for example, if at least one of the determined further road users starts moving again. The steps 90 to 130 in this case correspond to the step 90 to 130 of the first embodiment shown in FIG. 1.

In the event that it is determined in the step 130 that the repeatedly determined current speeds of all of the determined further road users do not exceed the second predetermined threshold value, for example in the event that none of the further road user starts moving again, the steps 120 and 130 are repeatedly carried out. In the event that, by contrast, it is determined in the step 130 that the repeatedly determined current speed of at least one of the determined further road users exceeds the predetermined threshold value, for example in the event that the second predetermined threshold value amounts to approximately 0 km/h and at least one of the determined further road users starts moving again, a current acceleration of the at least one further road user and/or a distance of the at least one further road user relative to the vehicle is determined in the shown embodiment in a step 140, for example again based on data determined by the at least one sensor of the motor vehicle.

A point of time, at which the outputting of the starting cue takes place, is determined furthermore in a step 150 based on the determined acceleration or the determined distance. For example, a point of time based on the determined acceleration and/or the determined distance is determined at which the motor vehicle is expected to start again. The point of time at which the starting cue is output can then be selected for example two to three seconds before this point of time. Once this point of time is reached, the outputting of the starting cue as shown by the step 160 takes place.

With the shown embodiments, a driver assistance system can thus be provided which makes possible the outputting of a starting cue even when either no vehicle is in front of the own vehicle for example on a traffic light or in the event that the road user located directly in front of the vehicle has not yet started moving again. The outputting of the starting cue for example takes place when with the help of a camera system or with the help of a so-called Car-to-X-communication it is detected that the traffic light switches from red to yellow. In the case of traffic lights which do not have a yellow light signal and go out directly, the outputting of the starting cue takes place when the red light goes out. The outputting of the starting cue in this case is triggered even when stationary vehicles exist in front of the own vehicle and have not yet started moving again. Furthermore, the outputting of the starting cue is triggered when generally vehicles in the own lane start moving although the vehicle standing directly in front of the vehicle is still stationary. This can for example be detected with the help of surround sensors such as radar. It is also possible to receive the information via a so-called Car-to-Car interface.

The shown embodiments advantageously make possible the optimal support the driver of the vehicle for example in congestion situations without the vehicle having to possess a so-called full speed range (ACC, Adaptive Cruise Control). During the stationary time, the driver can optimally relax which leads to the well-being of the driver.

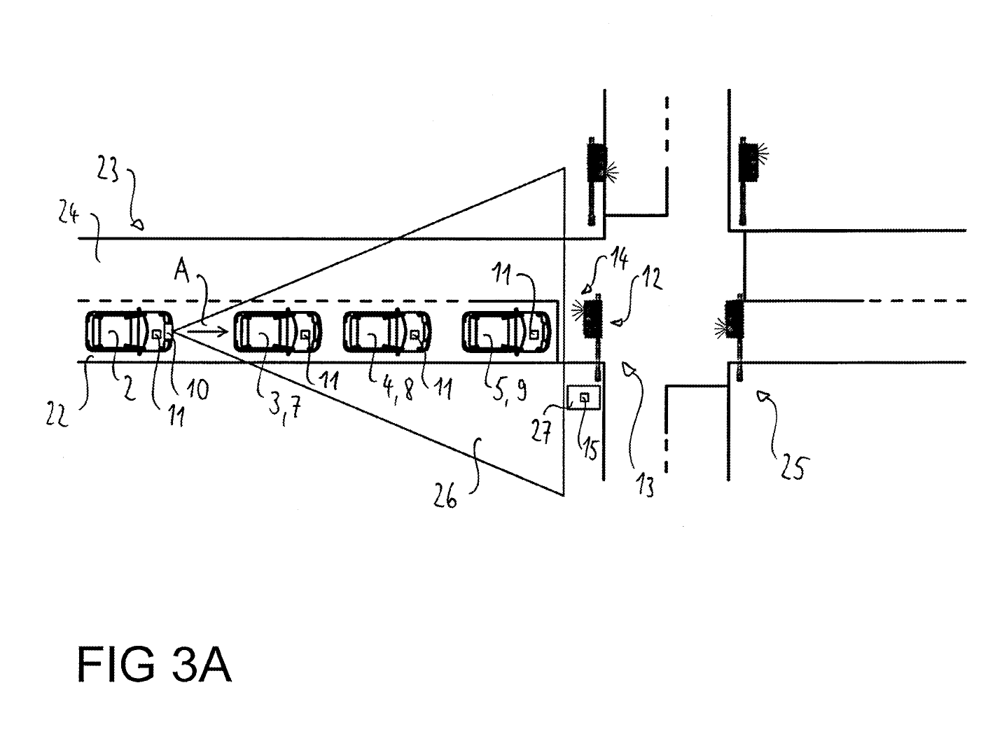

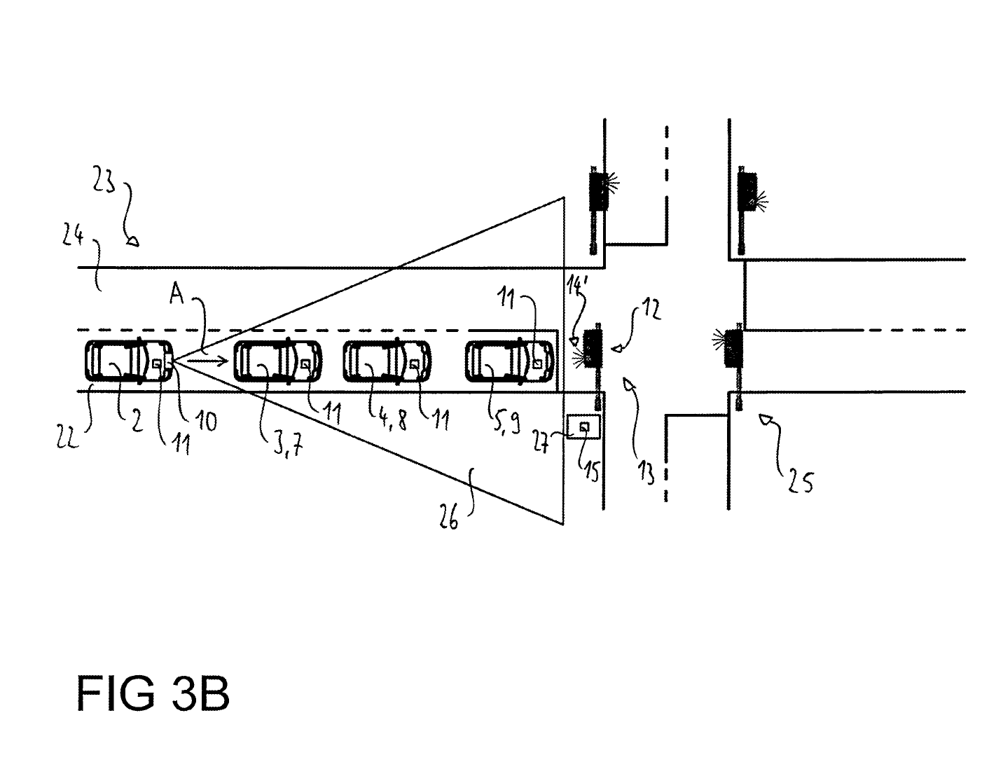

FIGS. 3A and 3B show an example of a traffic situation, in which the methods according to the embodiments, in particular the methods according to the embodiment shown in FIG. 1 and FIG. 2 can be employed. Here, FIG. 3A shows the traffic situation at a first point of time and FIG. 3B the traffic situation at a second, later point of time. Components with the same functions are marked with the same reference characters in the FIG. 3A and FIG. 3B.

In the shown traffic situation, a motor vehicle 2 is located on a lane 22 of a road 23 in the region of an intersection 25 in front of a set of traffic lights 12 in the form of traffic lights. In a longitudinal direction of the motor vehicle 2 schematically shown with an arrow A further road users 3, 4 and 5 are located on the lane 22 in front of the motor vehicle 2, which in the shown situation are formed by further motor vehicles 7, 8 and 9 respectively. Next to the lane 22, the road 23 additionally has a further lane 24.

The motor vehicle 2 has at least one sensor 10, which is designed for capturing objects in the region of surroundings 13 located in front of the motor vehicle 2 within a schematically represented capturing range 26. The at least one sensor 10 is for example designed as a radar sensor, as a lidar sensor or as an ultrasound sensor.

The further motor vehicles 7, 8 and 9 are at least partially located within the capturing range 26 of the sensor 10. Because of this, a current speed of the further motor vehicles 7, 8 and 9 can be determined based on the data determined by the sensor 10. Furthermore, the motor vehicle 2 and the further motor vehicles 7, 8 and 9 in the shown situation each have a Vehicle-to-Vehicle communication device 11. The current speed of the further motor vehicles 7, 8 and 9 can be additionally determined based on data received with the Vehicle-to-Vehicle communication device 11 of the motor vehicle 2.

At the first point of time shown in FIG. 3A, the motor vehicle 2 and the further motor vehicles 7, 8 and 9 are stationary. In addition, the set of traffic lights 12 displays a light signal 14 characterizing a stopping command. At the second point of time shown in FIG. 3B, the light signal 14 characterizing the stopping command has gone out and the set of traffic lights 12 displays a light signal 14′ characterizing a driving command. The motor vehicle 2 and the further motor vehicles 7 and 8 continue to be stationary at this stage. The motor vehicle 9, by contrast, has already restarted, i.e., started to move again. As is explained in more detail in connection with the following Fig, a starting cue within the motor vehicle 2 can be output in this case.

Furthermore, a starting cue can be output within the motor vehicle 2 in the event that it is determined that the motor vehicle 7 located directly in front of the motor vehicle 2 or the further motor vehicle 8 is starting to move again. A starting cue can be output furthermore in the event that it is determined that the light signal 14 characterizing the stopping command of the set of traffic lights 12 has gone out. Here, the type of the light signal currently output by the set of traffic lights 12 can be transmitted to the motor vehicle 2 in particular with a Vehicle-to-Vehicle infrastructure communication device 15, which for example is part of a roadside infrastructure device 27, which is also called a roadside unit. Furthermore, the type of the light signal currently output by the set of traffic lights 12 can be determined by means of an optical camera of the motor vehicle 2.

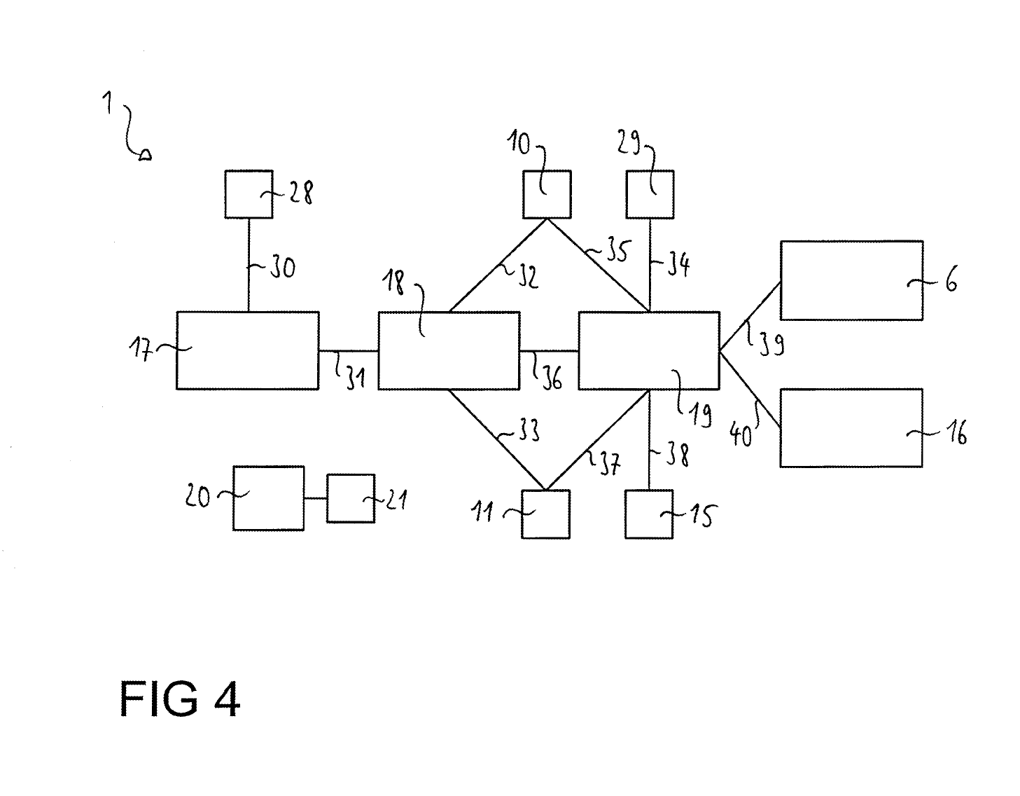

FIG. 4 shows a driver assistance system 1 of the motor vehicle 2 shown in FIG. 3 according to an embodiment. Components with the same functions as in FIG. 3 are marked with the reference characters and not explained again in the following. The driver assistance system 1 comprises a first determining device 17, which is designed for determining a current speed of the motor vehicle. To this end, the first determining device 17 is connected to a sensor 28, for example a wheel rotational speed sensor via a signal line 30.

In addition, the driver assistance system 1 comprises a second determining device 18, which is designed for determining a current speed of further road users located in a longitudinal direction of the motor vehicle in front of the motor vehicle. The second determining device 18 to this end is connected to the sensor 10 via a signal line 32 and to the Vehicle-to-Vehicle communication device 11 via a signal line 33. Furthermore, the second determining device 18 is connected to the first determining device 17 via a signal line 31.

In addition, the driver assistance system 1 comprises a third determining device 19. In the event that the determined current speed of the motor vehicle does not exceed a first predetermined threshold value and in the event that the determined current speed of a road user located directly in front of the motor vehicle does not exceed a second predetermined threshold value, the third determining device 19 in this case is designed for the repeated determining of the current speed of the road user located directly in front of the motor vehicle. Furthermore, in the event that the repeatedly determined current speed of the road user located directly in front of the motor vehicle does not exceed the second predetermined threshold value and in the event that the determined current speed of all of the determined further road users do not exceed the second predetermined threshold value, the third determining device 19 is designed for the repeated determining of the current speed of the determined further road users. The third determining device 19 to this end is connected to the sensor 10 via a signal line 35 and to the Vehicle-to-Vehicle communication device 11 via a signal line 37.

Furthermore, the third determining device 19 in the shown embodiment is designed for determining if a set of traffic lights and/or a level crossing barrier is located in the range of a surroundings located in front of the motor vehicle. If it is determined that a set of traffic lights and/or a level crossing barrier is located in the range, the third determining device 19 is additionally designed for determining a light signal output by the set of traffic lights or an opening state of the level crossing barrier. To this end, the third determining device 19 is connected to an optical camera 29 via a signal line 34 and to a Vehicle-to-Infrastructure communication device 15 of the motor vehicle via a signal line 38. Furthermore, the third determining device 19 is connected to the second determining device 18 via a signal line 36.

The driver assistance system 1 additionally comprises an output device 6, which is designed for outputting a starting cue in the event that the repeatedly determined current speed of at least one of the determined further road users exceeds the second predetermined threshold value. Furthermore, the output device 6 is designed for outputting a starting cue in the event that the repeatedly determined current speed of the road user located directly in front of the motor vehicle exceeds the second predetermined threshold value or in the event that the determined current speed of at least one of the determined further road users exceeds the second predetermined threshold value. Furthermore, the output device 6 is designed for outputting a starting cue in the event that it is determined that a light signal of the set of traffic lights characterizing a stopping command goes out and/or the level crossing barrier is opened. The output device 6 to this end is connected to the third determining device 19 via a signal line 39 and for example designed as a visual and/or acoustic and/or haptic output device.

Furthermore, the driver assistance system 1 in the shown embodiment is designed for the automatic actuating of a driving device 16 of the motor vehicle, in the event that the determined current speed of the motor vehicle does not exceed the first predetermined threshold value and the repeatedly determined current speed of the road user located directly in front of the motor vehicle exceeds the second predetermined threshold value. To this end, the driving device 16 is connected to the third determining device 19 via a signal line 40. The outputting of the starting cue in this case includes an outputting of information regarding an imminent automatic actuation of the driving device 16.

The driver assistance system 1 in the shown embodiment furthermore comprises a computer unit 20 and a computer-readable medium 21, wherein on the computer-readable medium 21 a computer program product is stored which, when it is executed on the computer unit 20, instructs the computer unit 20 to carry out the steps, in particular the steps of the embodiment shown in the FIG. 1 and FIG. 2, with the elements mentioned there in connection with the embodiments of the method. To this end, the computer unit 20 is directly or indirectly connected to the corresponding elements in a manner which is not shown in more detail.

Although at least one exemplary embodiment was shown in the preceding description, various changes and modifications can be carried out. The mentioned embodiments are merely examples and not intended in order to restrict the area of validity, the applicability or the configuration in any way. The preceding description rather makes available to the person skilled in the art a plan for implementing at least one exemplary embodiment. Numerous changes in the function and the arrangement of elements described in an exemplary embodiment can be made without leaving the scope of protection of the attached claims and their legal equivalents.

1. A method for operating a driver assistance system of a motor vehicle, comprising:
determining a current speed of the motor vehicle,
determining a current speed of a plurality of road users located in a longitudinal direction of the motor vehicle in front of the motor vehicle;
repeat determining of the current speed of a first road user of the plurality of road users located directly in front of the motor vehicle in the event that the current speed of the motor vehicle does not exceed a first predetermined threshold value and in the event that the current speed of the road user does not exceed a second predetermined threshold value;
repeat determining of the current speed of the plurality of road users in the event that the current speed of the road user located directly in front of the motor vehicle does not exceed the second predetermined threshold value and the current speed of the plurality of road users do not exceed the second predetermined threshold value;
outputting of a starting cue with an output device of the driver assistance system in the event that the current speed of at least one of the plurality of road users exceeds the second predetermined threshold value.

2. The method according to claim 1, wherein determining of the current speed of the plurality of road users located in the longitudinal direction of the motor vehicle in front of the motor vehicle comprises determining of a current speed of a plurality of motor vehicles located in the longitudinal direction of the motor vehicle in front of the motor vehicle.

3. The method according to claim 2, further comprising:
determining an acceleration of the at least one road user of the plurality of road users in the event that the repeatedly determined current speed of at least one of the plurality of road users exceeds the second predetermined threshold value; and
determining a point of time at which the outputting of the starting cue takes place based at least in part on the acceleration.

4. The method according to claim 1, wherein the outputting of the starting cue with the output device of the driver assistance system takes place in event that the repeat determining of the current speed of the road user located directly in front of the motor vehicle does not exceed the second predetermined threshold value and the current speed of at least one of the further road users exceeds the second predetermined threshold value.

5. The method according to claim 1, wherein determining of the current speed of the further road users, the repeat determining of the current speed of the road user located directly in front of the motor vehicle, and the repeat determining of the current speed of the further road users takes place based on data determined by at least one sensor of the motor vehicle.

6. The method according to claim 5, wherein the at least one sensor is an electromagnetic sensor.

7. The method according to claim 1, wherein determining of the current speed of the further road users, the repeat determining of the current speed of the road user located directly in front of the motor vehicle and the repeated determining of the current speed of the further road users takes place based at least in part on data received with a Vehicle-to-Vehicle communication device.

8. The method according to claim 1, further comprising determining if a set of traffic lights is located in a range of surroundings located in front of the motor vehicle in the event that the current speed of the motor vehicle does not exceed the first predetermined threshold value; and
wherein in event that it is determined that the set of traffic lights is located in the range, the outputting of the starting cue occurs as a function of a light signal output by the set of traffic lights.

9. The method according to claim 8, wherein the light signal output by the set of traffic lights is determined based at least in part on data received with a Vehicle-to-Infrastructure communication device.

10. The method according to claim 1, further comprising actuating a driving device of the motor vehicle, and
wherein the outputting of the starting cue comprises an outputting of information regarding an imminent automatic actuation of the driving device.

11. A driver assistance system for a motor vehicle, comprising:
a first determining device that is configured to determine a current speed of the motor vehicle;
a second determining device that is configured to determine a current speed of a plurality of road users located in a longitudinal direction of the motor vehicle in front of the motor vehicle; and
a third determining device that is configured to:
repeated determining the current speed of the road user located directly in front of the motor vehicle in event that the current speed of the motor vehicle does not exceed a first predetermined threshold value and the current speed of a road user located directly in front of the motor vehicle does not exceed a second predetermined threshold value;
repeated determining the current speed of the determined further road users in the event that the repeat determining the current speed of the road user located directly in front of the motor vehicle does not exceed the second predetermined threshold value and the current speed of all of the plurality of road users do not exceed the second predetermined threshold value; and
an output device that is configured to output a starting cue in event that a repeatedly determined current speed of at least one of the plurality of road users exceeds the second predetermined threshold value.

12. The driver assistance system according to claim 11, wherein the second determining device is further configured to determine a current speed of further motor vehicles located in the longitudinal direction of the motor vehicle in front of the motor vehicle.

13. The driver assistance system according to claim 11, wherein the third determining device is further configured to:
determine a point of time at which the outputting of the starting cue takes place, based at least in part on a determined acceleration of at least one road user of the plurality of road users and determine a distance of the at least one road user of the plurality of road users relative to the motor vehicle in the event that the repeat determining of the current speed of at least one of the plurality of road users exceeds the second predetermined threshold value.

14. A non-transitory computer readable medium embodying a computer program product, said computer program product comprising:
an operating program for operating a driver assistance system of a motor vehicle, the operating program configured to:
determine a current speed of the motor vehicle;
determine a current speed of a plurality of road users located in a longitudinal direction of the motor vehicle in front of the motor vehicle;
repeated determining of the current speed of the road user located directly in front of the motor vehicle in the event that the current speed of the motor vehicle does not exceed a first predetermined threshold value and in the event that the current speed of a road user located directly in front of the motor vehicle does not exceed a second predetermined threshold value;
repeated determining of the current speed of the determined further road users in the event that a repeatedly determined current speed of the road user located directly in front of the motor vehicle does not exceed the second predetermined threshold value and in the event that the current speed of all of the plurality of road users do not exceed the second predetermined threshold value; and
output a starting cue in the event that the repeatedly determined current speed of at least one road user of the plurality of road users exceeds the second predetermined threshold value.

15. (canceled)

16. The non-transitory computer readable medium embodying the computer program product according to claim 14, the operating program configured to:
determine an acceleration of the at least one road user of the plurality of road users in the event that the repeatedly determined current speed of at least one of the further road users exceeds the second predetermined threshold value; and
determine a point of time at which the outputting of the starting cue takes place based at least in part on the acceleration.

17. The non-transitory computer readable medium embodying the computer program product according to claim 14, wherein the outputting of the starting cue with an output device of the driver assistance system takes place in event that the repeat determining of the current speed of the road user located directly in front of the motor vehicle does not exceed the second predetermined threshold value and the current speed of at least one of the further road users exceeds the second predetermined threshold value.

18. The non-transitory computer readable medium embodying the computer program product according to claim 14, wherein the operating program is configured to determine the current speed of the further road users, the repeat determining of the current speed of the road user located directly in front of the motor vehicle, and the repeat determining of the current speed of the further road users takes place based on data determined by a sensor of the motor vehicle.

19. The non-transitory computer readable medium embodying the computer program product according to claim 18, wherein the sensor is an electromagnetic sensor.
